(19) United States
(12) Patent Application Publication
(10) Pub. No.: US 2010/0142485 A1
(43) Pub. Date: Jun. 10, 2010

(54) METHOD FOR PERFORMING HANDOVER IN WIRELESS COMMUNICATION SYSTEM

(76) Inventors: Eun Jong Lee, Gyeongki-do (KR); Doo Hyun Sung, Gyeongki-do (KR); Jae Hoon Chung, Gyeongki-do (KR); Han Gyu Cho, Gyeongki-do (KR); Kyu Jin Park, Gyeongki-do (KR)

Correspondence Address: MCKENNA LONG & ALDRIDGE LLP, 1900 K STREET, NW, WASHINGTON, DC, 20006, US

(21) Appl. No.: 12/733,065

(22) PCT Filed: Aug. 13, 2008
(86) PCT No.: PCT/KR2008/004712

§ 371 Date: Feb. 5, 2010

Related U.S. Application Data
(60) Provisional application No. 60/955,401, filed on Aug. 13, 2007.

(30) Foreign Application Priority Data
Nov. 7, 2007 (KR) 10-2007-0113033
Nov. 16, 2007 (KR) 10-2007-0117513
Nov. 16, 2007 (KR) 10-2007-0117515

(51) Int. Cl. H04W 36/08

(52) U.S. Cl. 370/331

(57) ABSTRACT

A method for performing a handover by a user equipment from a serving base station to a target base station includes transmitting a random access preamble to the target base station, receiving a random access response in response to the random access preamble; after receiving the random access response, transmitting a handover confirm message for indicating completion of the handover between the user equipment and the target base station, and transmitting a packet data sequence number report message indicating packet data received from the serving base station in a process of performing the handover. Repeated transmission of downlink data or uplink data can be avoided during a handover procedure.

### TECHNICAL FIELD

The present invention relates to wireless communications, and more particularly, to a method for performing a handover.

### BACKGROUND ART

Third generation partnership project (3GPP) mobile communication systems based on a wideband code division multiple access (WCDMA) radio access technology are widely spread all over the world. High-speed downlink packet access (HSDPA) that can be defined as a first evolutionary stage of WCDMA provides 3GPP with a radio access technique that is highly competitive in the mid-term future. However, since requirements and expectations of users and service providers are continuously increased and developments of competing radio access techniques are continuously in progress, new technical evolutions in 3GPP are required to secure competitiveness in the future.

An orthogonal frequency division multiplexing (OFDM) system capable of reducing inter-symbol interference with a low complexity is taken into consideration as one of next generation (after 3G) systems. In the OFDM system, serial input data symbols are converted into N parallel data symbols and are carried and transmitted on separate N subcarriers. The subcarriers maintain orthogonality in a frequency dimension. Orthogonal channels experience mutually independent frequency selective fading. In addition, since intervals of transmitted symbols are lengthened, inter-symbol interference can be minimized. Orthogonal frequency division multiple access (OFDMA) is a multiple access scheme in which multiple access is achieved by independently providing some of available subcarriers to a plurality of users when the OFDM is employed as a modulation scheme in a system in use. In the OFDMA, sub-carriers (i.e., frequency resources) are provided to the respective users, and the respective subcarriers are independently provided to the plurality of users. Thus, the sub-carriers generally do not overlap with one another. Eventually, the frequency resources are mutually exclusively allocated to the respective users.

In general, there are one or more cells within the coverage of a base station. One cell may be divided into a plurality of sectors. According to movement of a user equipment between sectors or between cells, a frequency band in use may change or the base station providing communication services may change. This is called a handover. For seamless communication services, the handover must be promptly performed, and a delay caused by the handover must be minimized.

Accordingly, there is a need for a method for effectively performing a handover.

### DISCLOSURE OF INVENTION

### Technical Problem

The present invention provides a method for effectively performing a handover.

### Technical Solution

In an aspect, a method for performing a handover by a user equipment from a serving base station to a target base station includes transmitting a random access preamble to the target base station, receiving a random access response in response to the random access preamble, after receiving the random access response, transmitting a handover confirm message for indicating completion of the handover between the user equipment and the target base station, and transmitting a packet data sequence number report message indicating packet data received from the serving base station in a process of performing the handover.

In another aspect, a method for performing a handover by a target base station in a wireless communication system includes receiving from a user equipment a random access preamble comprising contention-based random access signatures, the contention-based random access signatures are selected by the target base station, and transmitting a random access response addressed by an identifier for the user equipment within a cell in response to the random access preamble.

In another aspect, a method for performing a handover by a user equipment includes measuring a channel condition of a neighboring cell, reporting the channel condition to a base station, and receiving a handover command in response to the reporting, wherein the base station makes a handover decision, the user equipment operates in a sleep period for not receiving data during a handover preparation time required to transmit the handover command, and operates in an awake period during a handover command waiting time for receiving the handover command after the handover preparation time is over.

### ADVANTAGEOUS EFFECTS

Repeated transmission of downlink data or uplink data can be avoided during a handover procedure. Therefore, unnecessary waste of radio resources can be reduced and a flexible handover can be achieved.

When insufficient non-contention based random access signatures are assigned to a user equipment (UE) performing a handover, contention based random access signatures are selected and assigned. In addition, a random access channel (RACH) slot duration is assigned. A cell-radio network temporary identify (C-RNTI) is assigned to the UE performing the handover, and radio resources addressed by the C-RNTI are allocated so that collision with another UE attempting an initial random access is avoided. Therefore, a handover delay can be reduced.

Through a handover discontinuous reception (DRX) level, the handover delay can be reduced. Battery consumption of the UE can be reduced by minimizing an unnecessary awake period. In addition, since a sleep period and an awake period can be flexibly controlled by assigning a cell specific value in the handover DRX level, a handover can be adaptively performed according to a system characteristic.

### BRIEF DESCRIPTION OF THE DRAWINGS

FIG. 1 shows a structure of a wireless communication system.

FIG. 2 is a diagram showing functional split between an evolved universal terrestrial radio access network (E-UTRAN) and an evolved packet core (EPC)

FIG. 3 is a block diagram showing constitutional elements of a user equipment (UE).

FIG. 4 is a diagram showing a radio protocol architecture for a user plane.

FIG. 5 is a diagram showing a radio protocol architecture for a control plane.

FIG. 6 shows an example of a method for performing a handover.

FIG. 7 shows an example of transmitting downlink/uplink data during a handover procedure.

FIG. 8 is a flow diagram showing a method for performing a handover according to an embodiment of the present invention.

FIG. 9 shows an example of a radio link control (RLC) protocol data unit (PDU) for transmitting a handover confirm message and a packet data sequence number report message.

FIG. 10 shows an example of a packet data convergence protocol (PDCP) PDU for a packet data sequence number report message.

FIG. 11 is a flow diagram showing a method for performing a handover according to another embodiment of the present invention.

FIG. 12 shows an example of a random access method.

FIG. 13 is a flow diagram showing a method for performing a handover according to another embodiment of the present invention.

FIG. 14 is a flowchart showing a method for performing a handover according to another embodiment of the present invention.

FIG. 15 shows a reception mode level of a UE.

FIG. 16 shows a handover procedure in a long-discontinuous reception (DRX).

FIG. 17 shows a method for performing a handover in a continuous reception level (non-DRX).

FIG. 18 shows a case where no handover occurs in a non-DRX.

FIG. 19 shows a method for performing a handover in a short-DRX.

FIG. 20 shows a case where a handover does not occur in a short-DRX.

FIG. 21 shows a reception mode level of a UE according to an embodiment of the present invention.

FIG. 22 shows a method for performing a handover by using a handover DRX level according to an embodiment of the present invention.

FIG. 23 shows another example of a method for performing a handover by using a handover DRX level.

FIG. 24 shows a method for performing a handover according to another embodiment of the present invention.

FIG. 25 shows a method for performing a handover according to another embodiment of the present invention.

FIG. 26 shows a method for performing a handover according to another embodiment of the present invention.

FIG. 27 shows a method for performing a handover according to another embodiment of the present invention.

FIG. 28 shows a method for performing a handover according to another embodiment of the present invention.

### MODE FOR THE INVENTION

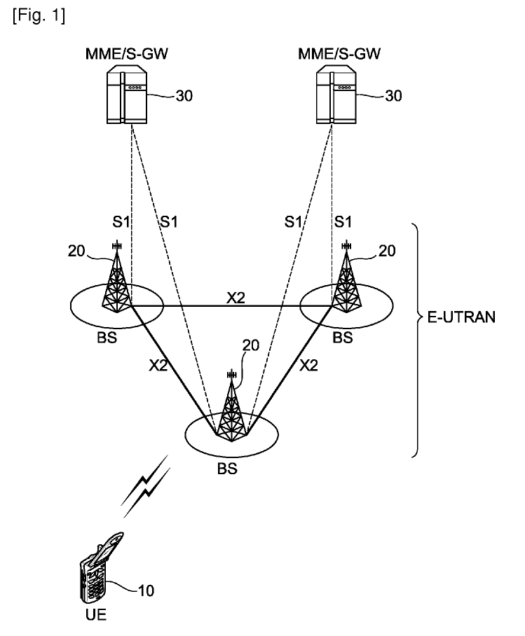

FIG. 1 shows a structure of a wireless communication system. The wireless communication system may have a network structure of an evolved-universal mobile telecommunications system (E-UMTS). The E-UMTS may be referred to as a long-term evolution (LTE) system. The wireless communication system can be widely deployed to provide a variety of communication services, such as voices, packet data, etc.

Referring to FIG. 1, an evolved-UMTS terrestrial radio access network (E-UTRAN) includes at least one base station (BS) 20 which provides a control plane and a user plane.

A user equipment (UE) 10 may be fixed or mobile, and may be referred to as another terminology, such as a mobile station (MS), a user terminal (UT), a subscriber station (SS), a wireless device, etc. The BS 20 is generally a fixed station that communicates with the UE 10 and may be referred to as another terminology, such as an evolved node-B (eNB), a base transceiver system (BTS), an access point, etc. There are one or more cells within the coverage of the BS 20. Interfaces for transmitting user traffic or control traffic may be used between the BSs 20. Hereinafter, downlink is defined as a communication link from the BS 20 to the UE 10, and uplink is defined as a communication link from the UE 10 to the BS 20.

The BSs 20 are interconnected by means of an X2 interface. The BSs 20 are also connected by means of an S1 interface to an evolved packet core (EPC), more specifically, to a mobility management entity (MME)/system architecture evolution (SAE)-gateway (GW) 30. The S1 interface supports a many-to-many relation between the BS 20 and the MME/SAE-GW 30.

The radio interface protocol horizontally includes a physical layer, a data link layer, and a network layer, and vertically includes a user plane for data information transfer and a control plane for control signaling delivery.

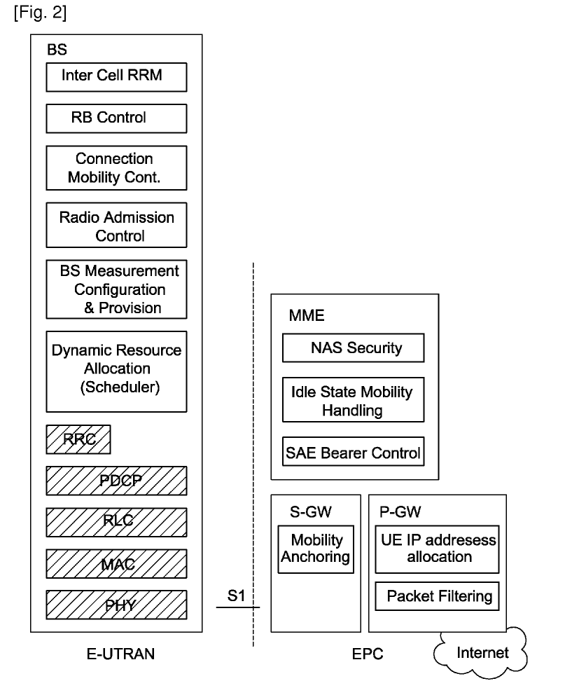

FIG. 2 is a diagram showing functional split between the E-UTRAN and the EPC.

Referring to FIG. 2, slashed boxes indicate radio protocol layers and white boxes indicate functional entities of the control plane.

The BS performs the following functions: (1) functions for radio resource management (RRM) such as radio bearer control, radio admission control, connection mobility control, and dynamic allocation of resources to the UE; (2) Internet protocol (IP) header compression and encryption of user data streams; (3) routing of user plane data to the SAE-GW; (4) scheduling and transmission of paging messages; (5) scheduling and transmission of broadcast information; and (6) measurement and measurement reporting configuration for mobility and scheduling.

The MME performs the following functions: (1) distribution of paging messages to the BSs; (2) security control; (3) idle state mobility control; (4) SAE bearer control; and (5) ciphering and integrity protection of non-access stratum (NAS) signaling.

The SAE-GW performs the following functions: (1) termination of a user plane packet for paging; and (2) user plane switching for the support of UE mobility.

Layers of a radio interface protocol between the UE and the network can be classified into L1 layer (a first layer), L2 layer (a second layer), and L3 layer (a third layer) based on the lower three layers of the open system interconnection (OSI) model that is well-known in the communication system. A physical layer, or simply a PHY layer, belongs to the first layer and provides an information transfer service through a physical channel. A radio resource control (RRC) layer belongs to the third layer and serves to control radio resources between the UE and the network. The UE and the network exchange RRC messages via the RRC layer.

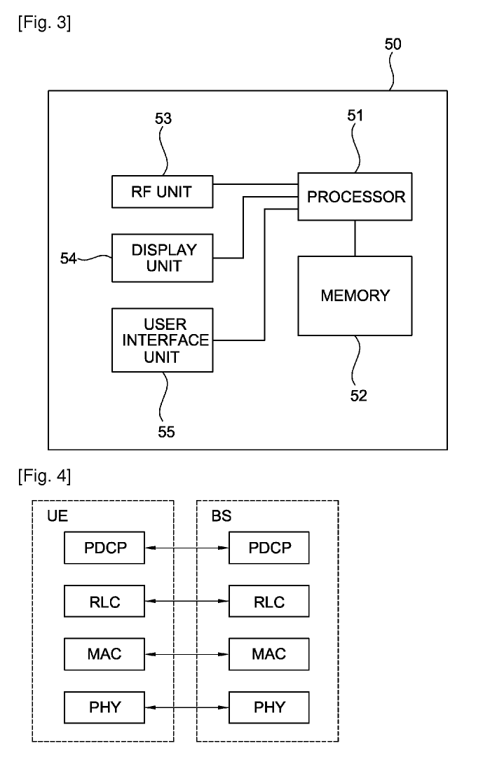

FIG. 3 is a block diagram showing constitutional elements of the UE. A UE 50 includes a processor 51, a memory 52, a radio frequency (RF) unit 53, a display unit 54, and a user interface unit 55. Layers of a radio interface protocol are implemented in the processor 51. The processor 51 provides the control plane and the user plane. The function of each layer can be implemented in the processor 51. The processor 51 performs an operation for obtaining system information to be described below.

The memory 52 is coupled to the processor 51 and stores an operating system, applications, and general files. The display unit 54 displays a variety of information of the UE 50 and may use a well-known element such as a liquid crystal display (LCD), an organic light emitting diode (OLED), etc. The user interface unit 55 can be configured with a combination of well-known user interfaces such as a keypad, a touch screen, etc. The RF unit 53 is coupled to the processor 51 and transmits and/or receives radio signals.

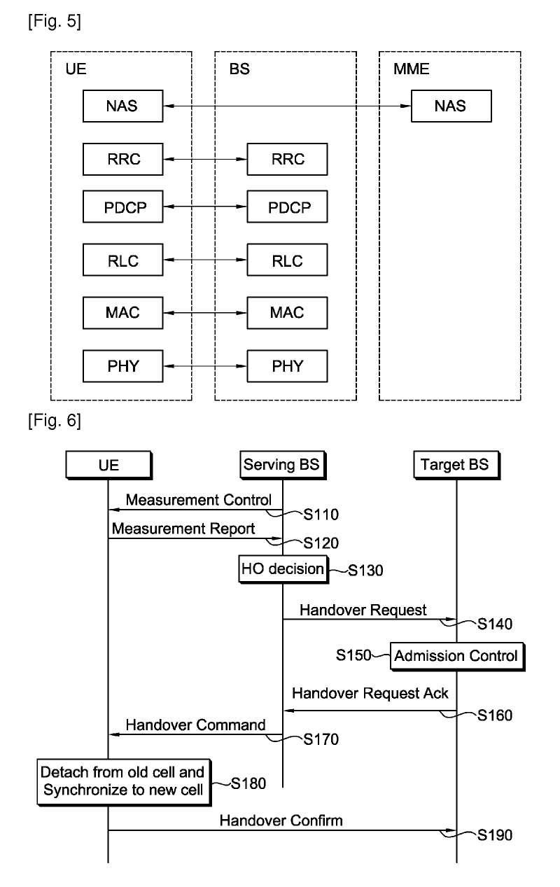

FIG. 4 is a diagram showing a radio protocol architecture for the user plane. FIG. 5 is a diagram showing a radio protocol architecture for the control plane. They illustrate an architecture of a radio interface protocol between the UE and the E-UTRAN. The user plane is a protocol stack for user data transmission. The control plane is a protocol stack for control signal transmission.

Referring to FIGS. 4 and 5, a PHY layer belongs to the first layer and provides an upper layer with an information transfer service through a physical channel. The PHY layer is coupled with a medium access control (MAC) layer, i.e., an upper layer of the PHY layer, through a transport channel. Data is transferred between the MAC layer and the PHY layer through the transport channel. Between different PHY layers (i.e., a PHY layer of a transmitter and a PHY layer of a receiver), data are transferred through the physical channel. The PHY layer can be modulated by orthogonal frequency division multiplexing (OFDM). Time and/or frequency can be utilized as radio resources.

The MAC layer belongs to the second layer and provides services to a radio link control (RLC) layer, i.e., an upper layer of the MAC layer, through a logical channel. The RLC layer in the second layer supports reliable data transfer. There are three operating modes in the RLC layer, that is, a transparent mode (TM), an unacknowledged mode (UM), and an acknowledged mode (AM) according to a data transfer method. An AM RLC provides bidirectional data transmission services and supports retransmission when the transfer of a RLC protocol data unit (PDU) fails.

A packet data convergence protocol (PDCP) layer belongs to the second layer and performs a header compression function. When transmitting an Internet protocol (IP) packet such as an IPv4 packet or an IPv6 packet, a header of the IP packet may contain relatively large and unnecessary control information. The PDCP layer reduces a header size of the IP packet so as to efficiently transmit the IP packet.

A radio resource control (RRC) layer belongs to the third layer and is defined only in the control plane. The RRC layer serves to control the logical channel, the transport channel, and the physical channel in association with configuration, reconfiguration and release of radio bearers (RBs). An RB is a service provided by the second layer for data transmission between the UE and the E-UTRAN. When an RRC connection is established between an RRC layer of the UE and an RRC layer of the network, it is called that the UE is in an RRC connected mode. When the RRC connection is not established yet, it is called that the UE is in an RRC idle mode.

A non-access stratum (NAS) layer belongs to an upper layer of the RRC layer and serves to perform authentication, SAE bearer management, security control, etc.

FIG. 6 shows an example of a method for performing a handover.

Referring to FIG. 6, a serving BS providing a wireless communication service to a UE transmits a measurement control message to the UE (step S110). The measurement control message is used to allow the UE to measure and report a channel condition of a neighboring cell in order to perform a handover (HO).

The UE measures the channel condition of the neighboring cell and transmits a measurement report message to the serving BS (step S120). The measurement report message may indicate a channel condition of one nearest neighboring cell or may indicate channel conditions of a plurality of neighboring cells. In addition, the UE may measure a downlink channel condition of the serving BS and the UE and also report the downlink channel condition.

According to the measurement report message, the serving BS makes a HO decision with respect to the UE (step S130). The serving BS may determine the handover when the channel condition of the neighboring cell is superior to that of the serving BS. Upon determining the handover of the UE, the serving BS transmits a handover request message to a target BS (step S140).

Upon receiving the handover request message, the target BS controls admission of the US (step S150). Upon determining admission of the UE, the target BS transmits a handover request acknowledgement (ACK) message to the serving BS (step S160).

Upon receiving the handover request ACK message from the target BS, the serving BS transmits a handover command message to the UE (step S170). The handover command message is used to inform the UE that the handover is performed. A series of above operations starting from the HO decision of the serving BS to the transmission of the handover command message is referred to as a handover preparation process.

Upon receiving the handover command message, the UE is disconnected from the serving BS and is synchronized with the target BS (step S180), and transmits a handover confirm message to the target BS (step S190). Thereafter, the serving BS removes a data buffered for the UE from a buffer and de-allocates radio resources allocated to the UE. The target BS allocates radio resources for data transmission of the UE. This is referred to as a handover execution process. Then, the target BS acts as the serving BS providing the wireless communication service to the UE, which is referred to as a handover completion process.

<Method for Performing Handover Using Data Sequence Number Report Message>

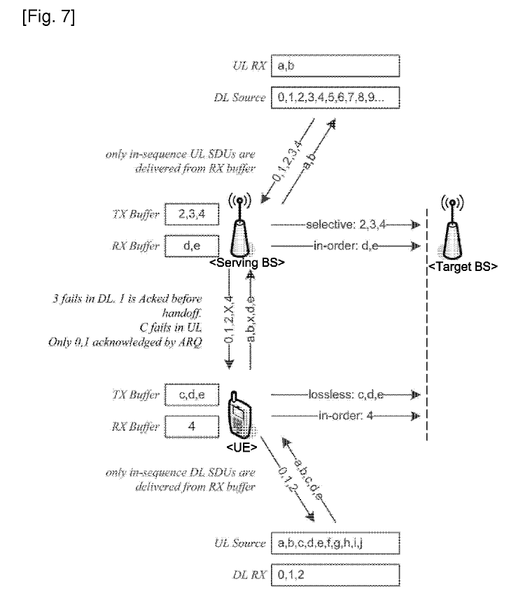

FIG. 7 shows an example of transmitting downlink/uplink data during a handover procedure.

Referring to FIG. 7, in the handover procedure, a serving BS denotes a BS which is currently providing a wireless communication service to a UE, and a target BS denotes a BS which will provide the wireless communication service to the UE. Data may be transmitted between the UE and the BS in a unit of block data (or packet data). Each block data may be indicated by a sequence number (SN).

In a downlink scenario, ‘0,1,2,3,4,5,6,7,8,9, . . . ’ is downlink (DL) data (i.e., DL source) to be transmitted to the UE. It is assumed herein that the serving BS transmits ‘0,1,2,3,4’ to the UE, but ‘3’ is not received by the UE due to errors.

If the serving BS receives an ACK signal only for ‘0,1’ from the UE before the handover is performed, ‘2,3,4’ is buffered in a transmit (TX) buffer of the serving BS. Further, ‘0,1,2’ is downlink data (DL RX) successfully received by the UE, and ‘4’ is buffered in a receive (RX) buffer of the UE. When the handover is performed, the serving BS transmits ‘2,3,4’ buffered in the TX buffer to the target BS. The target BS regards that ‘2,3,4’ received from the serving BS is not yet transmitted to the UE, and thus transmits ‘2,3,4’ to the UE. From the perspective of the UE, only ‘3’ needs to be received without having to receive all of ‘2,3,4’. Therefore, in a case where data is transmitted to the target BS when the serving BS fails in receiving the ACK signal, if the target BS transmits all of ‘2,3,4’ to the UE, it is unnecessary waste of resources. In addition, it is an unnecessary overhead when processing is performed in an RLC and a PDCP.

If the UE reports to the target BS an SN of ‘4’ which is last received by the UE, it can be known that the target BS will transmit ‘5,6,7,8,9, . . . ’ without having to transmit ‘2,3,4’. In addition, if the UE reports to the target BS an SN of ‘3’ in which an error occurs, the target BS may retransmit only ‘3’ to the UE without having to transmit all of ‘2,3,4’. That is, unnecessary waste of resources can be reduced when the UE reports to the target BS an SN of data required to be retransmitted.

In an uplink scenario, ‘a,b,c,d,e,f,g,h,i,j’ is uplink (UL) data (i.e., UL source) to be transmitted to the BS. It is assumed herein that the UE transmits ‘a,b,c,d,e’ to the serving BS, but ‘c’ is not received by the serving BS due to errors.

If the UE receives an ACK signal only for ‘a,b’ from the serving BS, ‘c,d,e’ is buffered in a TX buffer of the UE. The UE retransmits ‘c,d,e’ buffered in the TX buffer to the target BS. In an RX buffer of the serving BS, ‘d,e’ received from the UE is buffered. The serving BS transmits ‘d,e’ to the target BS. Since the target BS receives ‘d,e’ from the serving BS, the target BS has to receive only ‘c’ from the UE. If the UE transmits all of ‘c,d,e’ to the target BS, it is unnecessary waste of resources.

If the target BS reports to the UE an SN of ‘e’ which is last received by the target BS, it can be known that the UE does not have to retransmit ‘c,d,e’. In addition, if the serving BS reports to the target BS an SN of ‘c’ in which an error occurs and if the target BS reports to the UE the SN of ‘c’, the UE may retransmit only ‘c’ to the target BS without having to transmit all of ‘c,d,e’. That is, unnecessary waste of resources can be reduced when the target BS reports to the UE an SN of data required to be retransmitted.

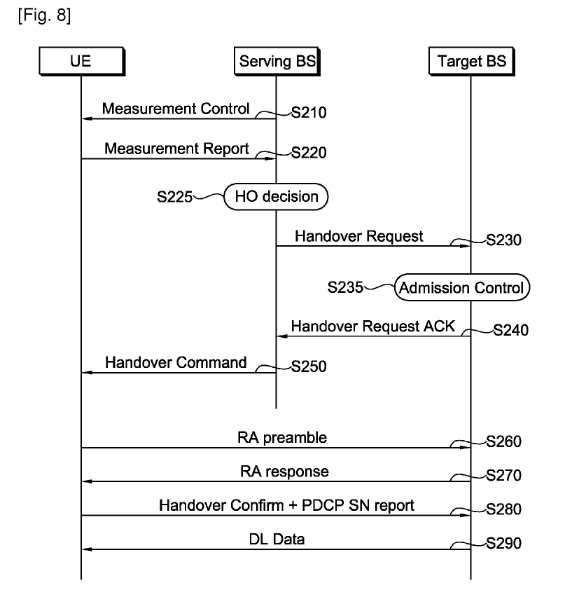

FIG. 8 is a flow diagram showing a method for performing a handover according to an embodiment of the present invention.

Referring to FIG. 8, a serving BS transmits a measurement control message to a UE (step S210). The measurement control message is used to allow the UE to measure and report a channel condition of a neighboring cell in order to perform a handover (HO).

The UE measures the channel condition of the neighboring cell and transmits a measurement report message to the serving BS (step S220). The measurement report message may indicate a channel condition of one nearest neighboring cell or may indicate channel conditions of a plurality of neighboring cells. In addition, the UE may measure a downlink channel condition of the serving BS and the UE and also report the downlink channel condition.

According to the measurement report message, the serving BS makes a HO decision with respect to the UE (step S225). The serving BS may determine the handover when a channel condition of the neighboring cell is superior to that of the serving BS. Upon determining the handover of the UE, the serving BS transmits a handover request message to a target BS (step S230).

Upon receiving the handover request message, the target BS controls admission of the US (step S235). Upon determining admission of the UE, the target BS transmits a handover request ACK message to the serving BS (step S240). The handover request ACK message may include a plurality of parameters required for access, such as a cell-radio network temporary identify (C-RNTI), a random access signature, etc., provided from the target BS. The C-RNTI is used to identify UEs within a cell so that an RRC connection of the UEs within the cell can be identified. The random access signature may be a non-contention based random access signature for identifying a UE performing a handover.

Upon receiving the handover request ACK message from the target BS, the serving BS transmits a handover command message to the UE (step S250). The handover command message is used to inform the UE that the handover is performed. The handover command message may include parameters required for the handover such as the identifier for the C-RNTI, the random access signature, etc., provided from the target BS. After transmitting the handover command message, the serving BS transmits data stored in its TX buffer to the target BS so that the target BS can transmit data subsequent to the data transmitted by the serving BS.

Upon receiving the handover command message, the UE transmits to the target BS a random access (RA) preamble for a handover (step S260). The UE selects the random access signature assigned by the target BS and a random access channel (RACH) occasion and transmits the RA preamble to the BS.

In response to the RA preamble, the target BS transmits an RA response message (step S270). The RA response message may include timing offset information (e.g., time advance (TA)) and information regarding uplink radio resource allocation for transmission of an RRC connection request message.

The UE transmits a handover confirm message and a PDCP SN report message to the target BS (step S280). The PDCP SN report message means a packet data sequence number report message. The handover confirm message may be an RRC connection request message. The handover confirm message is used to report completion of a handover execution process between the UE and the target BS. The PDCP SN report message may represent an SN of packet data which is last received by the UE from the serving BS. Alternatively, the PDCP SN report message may represent a SN of erroneous packet data among packet data received by the UE from the serving BS. The handover confirm message is RRC signaling generated in an RRC layer. The PDCP SN report message is PDCP signaling generated in a PDCP layer. The handover confirm message and the PDCP SN report message may be transmitted by being multiplexed. The handover confirm message and the PDCP SN report message may be multiplexed in the RRC layer or the RLC layer, which will be described below.

The target BS transmits DL data to the UE (step S290). According to the PDCP SN report message, the target BS can confirm data which is to be transmitted to the UE and which is subsequent to data transmitted by the serving BS. If the PDCP SN report message indicates an SN (SN=n) of packet data which is last received by the UE from the serving BS, packet data having a next SN (i.e., SN=n+1) is next packet data to be transmitted by the target BS to the UE. If the PDCP SN report message indicates an SN (SN=k) of erroneous packet data among packet data received by the UE from the serving BS, the target BS retransmits packet data having the same SN (SN=k) to the UE. As such, when the UE reports to the target BS an SN of packet data which is last received by the UE or an SN of erroneous packet data, the target BS can selectively transmit data which is unsuccessfully received by the UE, without having to transmit entire data stored in the TX buffer of the serving BS to the UE. Therefore, unnecessary waste of downlink radio resources can be reduced, and a system overhead caused by data retransmission can be reduced.

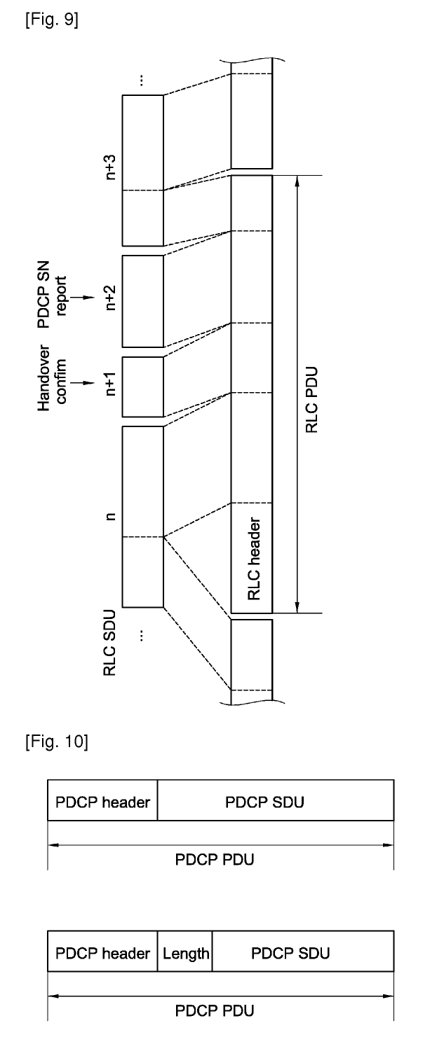

FIG. 9 shows an example of an RLC PDU for transmitting a handover confirm message and a PDCP SN report message.

Referring to FIG. 9, a packet data unit (PDU) denotes a block data unit delivered from a current layer to a different layer, and a service data unit (SDU) denotes a block data unit delivered from the different layer to the current layer. A block data unit delivered from an RLC layer to the different layer is referred to as an RLC PDU. The RLC PDU includes at least one RLC SDU delivered from the different layer. The RLC SDU may be segmented, and the RLC SDU segments may be included in different RLC PDUs. The RLC PDU is appended with an RLC header including a sequence number so that a receiving end can know which RLC PDU is lost during transmission.

The handover confirm message and the PDCP SN report message may be multiplexed in the RLC layer. The handover confirm message may be provided from the RRC layer to the RLC layer and may be included in the RLC PDU. The PDCP SN report message may be provided from the PDCP layer to the RLC layer and may be included in the RLC PDU. That is, the handover confirm message and the PDCP SN report message may be included and multiplexed in one RLC PDU. Alternatively, the handover confirm message and the PDCP SN report message may be segmented and the resultant segments may be included in a plurality of RLC PDUs.

Meanwhile, the handover confirm message and the PDCP SN report message may be multiplexed in the RRC layer. The PDCP SN report message may be provided from the PDCP layer to the RLC layer and may be included in the RLC PDU. This RLC PDU may be provided to the RRC layer and be multiplexed with the handover confirm message in the RRC layer. Alternatively, the PDCP SN report message may be directly transmitted to be multiplexed from the PDCP layer to the RRC layer. Thereafter, the RLC SDU, in which the handover confirm message and the PDCP SN report message are multiplexed, is received from the RRC layer to configure the RLC PDU.

FIG. 10 shows an example of a PDCP PDU for a PDCP SN report message. The PDCP SN report message is transmitted by a UE to a BS.

Referring to FIG. 10, the PDCP PDU includes at least one PDCP SDU and at least one PDCP header. The PDCP header includes a sequence number (SN) for identifying the PDCP PDU. The SN included in the PDCP header is independent from that included in an RLC header. The PDCP SDU may carry a control signal or user data provided from an NAS layer to an RLC layer. The PDCP SN report message may be carried on the PDCP PDU through PDCP signaling.

The PDCP SN report message may indicate an SN of packet data which is last received by the UE from a serving BS. When the UE reports to a target BS the SN of the packet data which is last received from the serving BS, packet data having a next SN is next packet data to be transmitted by the target BS. For example, the target BS can distinguish packet data (i.e., first data), which has already been received from the serving BS but an ACK signal is not transmitted, from packet data (i.e., second data) which is provided from a gateway to the serving BS after the UE releases a connection from the serving BS wherein the gateway does not know that the UE has released the connection. Further, the target BS transmits data starting from the second data having an SN subsequent to that included in the PDCP SN report message. That is, since the target BS does not transmit the first data in a repetitive manner, waste of resources can be reduced.

The PDCP SN report message may indicate an SN of erroneous packet data among packet data received by the UE from the serving BS. When the UE reports to the target BS the SN of the erroneous packet data among the packet data received from the serving BS, the target BS retransmits the erroneous packet data.

As a first method for indicating the SN of erroneous packet data, the SN may be represented without changing its format. In this case, a size of the PDCP SN report message may vary depending on an amount of the erroneous packet data. For example, an SN of a PDCP may be represented with 16 bits. In addition, the size of the PDCP SN report message may significantly increase in proportion to the amount of the erroneous PDCP SDU.

As a second method for indicating the SN of the erroneous packet data, the SN of the packet data may be represented in a bitmap format. An SN (a first SN) of packet data which is last received from the serving BS can be used when the SN (a second SN) of the erroneous packet data is represented in a bitmap format. For example, if the first SN is n, when errors occur in packet data having an SN of n−4 and packet data having an SN of n−2, the second SN can be represented in a bitmap format of ‘0101’. When the SN of the erroneous packet data is represented in the bitmap format, the PDCP SN report message can be generated and transmitted by using a less number of bits in comparison with the first method. Alternatively, packet data (first data) for which an ACK signal is last transmitted among packet data received by the UE from the serving BS may be determined as reference data. Then, whether packet data (second data) is further received after receiving the reference data can be represented in a bitmap format. For example, if an SN of the first data is n and an SN of the second data is n+2 and n+3, the reception status can be represented in a bitmap format of ‘011’ and the target BS can know that packet data having an SN of n+1 is erroneous packet data. In this case, the UE does not have to allow the PDCP SN report message to include an SN of packet data (i.e., reference data) for which the ACK signal is last transmitted. In addition, the target BS can know the erroneous packet data by receiving a last RLC status report message of the UE from the serving BS. Since an SN report message transmitted by the UE does not have to include a 16-bit PDCP SN, a data size can be further reduced. Herein, the size of bitmap representing the PDCP SN report message may be fixed or variable. If the bitmap is fixed in size, that is, the PDCP SN report message is fixed in size, the size can be determined in consideration of an automatic repeat request (ARQ) process and the number of PDCP PDUs included in the RLC PDU.

In the first method and the second method, the PDCP SN report message may have a variable size according to the amount of erroneous packet data. To represent such a variable size, a length field for defining the size of the PDCP SN report message may be further included in the PDCP PDU. That is, the PDCP PDU carrying the PDCP SN report message may include a PDCP header, a length field, and a PDCP SDU. The length field may indicate the amount of erroneous packet data or may directly indicate the size of the SN report message. The length field is not fixed in location, and thus may be located in any positions within the PDCP PDU.

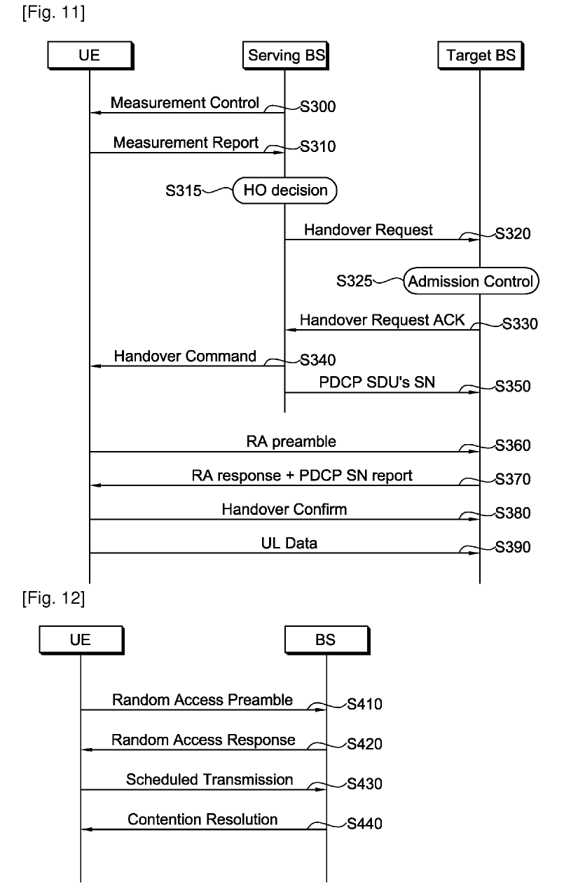

FIG. 11 is a flow diagram showing a method for performing a handover according to another embodiment of the present invention.

Referring to FIG. 11, a serving BS transmits a measurement control message to a UE (step S300). The UE measures a channel condition of a neighboring cell and transmits a measurement report message to the serving BS (step S310).

According to the measurement report message, the serving BS makes a HO decision with respect to the UE (step S315). Upon determining the handover of the UE, the serving BS transmits a handover request message to a target BS (step S320).

Upon receiving the handover request message, the target BS controls admission of the US (step S325). Upon determining admission of the UE, the target BS transmits a handover request ACK message to the serving BS (step S330).

Upon receiving the handover request ACK message from the target BS, the serving BS transmits a handover command message to the UE (step S340). The serving BS reports to the target BS a PDCP SDU s SN message received from the UE (step S350). A PDCP SDU s SN may be an SN of last packet data among data sequentially received from the UE without errors.

Upon receiving the handover command message, the UE transmits to the target BS a random access (RA) preamble for the handover (step S360).

In response to the RA preamble, the target BS transmits an RA response message and a PDCP SN report (i.e., packet data sequence number report) message to the UE (step S370). The PDCP SN report message may include the PDCP SDU' SN provided from the serving BS. That is, the target BS may report to the UE the SN of the last packet data among data sequentially received without errors by the serving BS from the UE. Alternatively, the PDCP SN report message may represent an SN of erroneous packet data in a bitmap format. That is, for packet data transmitted by the UE to the serving BS, packet data for which an ACK signal is last transmitted by the serving BS may be determined as reference data. Then, whether packet data is further received after receiving the reference packet data can be represented in a bitmap format. In this case, an SN of the reference packet data is not included in the PDCP SN report message. The UE and the target BS can implicitly know the SN of the reference packet data.

The UE transmits a handover confirm message to the target BS (step S380). The UE transmits UL data to the target BS (step S390). The UE can transmit packet data subsequent to the packet data transmitted to the serving BS according to the PDCP SN report message. For example, in a case where the UE has successfully transmitted data to the serving BS but performs a handover to the target BS before receiving an ACK signal from the serving BS, the UE has to retransmit to the target BS data for which the ACK signal is not received. However, if the UE receives the PDCP SN report message from the target BS, the UE can know an SN of the successfully received packet data. Thus, the UE can transmit the subsequent packet data without having to retransmit the data for which the ACK signal is not received. In addition, if the target BS reports the SN of erroneous packet data among packet data for which the ACK signal is not received by the UE, the UE retransmits only the erroneous packet data without having to transmit all packet data for which the ACK signal is not received. As described above with reference to FIG. 10, the PDCP SN report message may be represented with an SN of packet data without changing its format or may be represented in a bitmap format according to an SN of last received packet data or an SN of packet data for which a last ACK signal is received. Meanwhile, as described above with reference to FIG. 9, the RA response message and the PDCP SN report message may be multiplexed in an RRC layer or an RLC layer.

<Method for Performing Handover Using Contention-Based Random Access>

FIG. 12 shows an example of a random access method. In this example, the method is a contention based random access method.

Referring to FIG. 12, according to system information received from a BS or information included in a paging message, a UE selects an available random access signature and an RACH occasion and then transmits a random access preamble to the BS (step S410).

After receiving the random access preamble, the BS transmits a random access response to the UE (step S420). The random access response may include timing offset information (e.g., time advance (TA)) and, information regarding uplink radio resource allocation for transmission of an RRC connection request message. According to the system information and the paging information, the BS reports information regarding a random access preamble identifier to the UE. The random access preamble identifier identifies the random access response and may be referred to as a random access-radio network temporary identify (RA-RNTI). The random access response may be transmitted through a downlink-shared channel (DL-SCH). The RA-RNTI may be transmitted through a DL L1/L2 control channel or DL L1/L2 control signaling.

After receiving the random access response, the UE transmits a scheduled transmission message according to information which regards radio resource allocation and which is included in the random access response message (step S430). The scheduled transmission message may be an RRC connection request message. The UE monitors the RA-RNTI transmitted through the DL L1/L2 control channel, and reads a corresponding DL-SCH message. In addition, the UE transmits the scheduled transmission message according to random access response information transmitted using the DL-SCH message.

After receiving the scheduling transmission message from the UE, the BS transmits a contention resolution message to the UE (step S440).

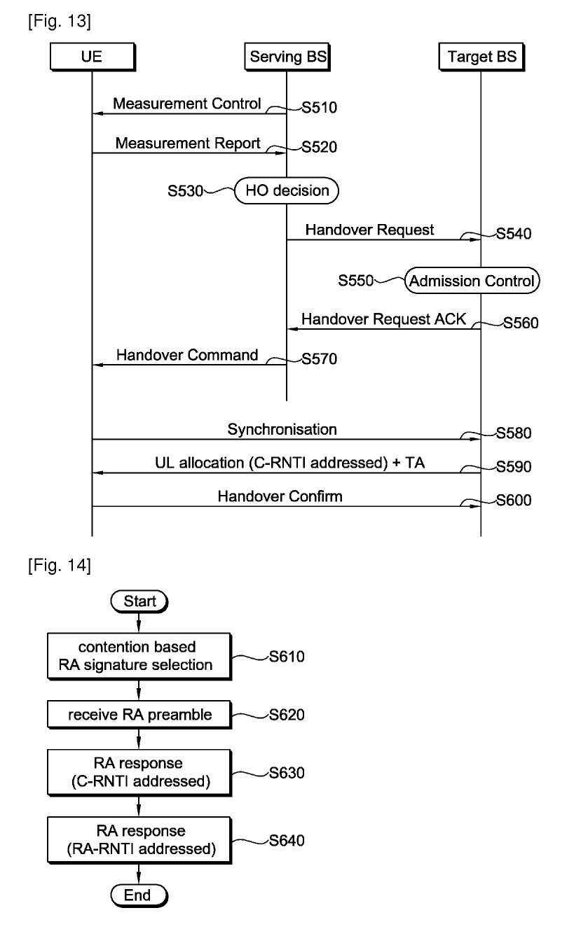

FIG. 13 is a flow diagram showing a method for performing a handover according to another embodiment of the present invention.

Referring to FIG. 13, a serving BS providing a wireless communication service to a UE transmits a measurement control message to the UE (step S510). The measurement control message is used to allow the UE to measure and report a channel condition of a neighboring cell in order to perform a handover (HO).

The UE measures the channel condition of the neighboring cell and transmits a measurement report message to the serving BS (step S520). The measurement report message may indicate a channel condition of one nearest neighboring cell or may indicate channel conditions of a plurality of neighboring cells. In addition, the UE may measure a downlink channel condition between the serving BS and the UE and also report the downlink channel condition.

According to the measurement report message, the serving BS makes a HO decision with respect to the UE (step S530). The serving BS may determine the handover when a channel condition of the serving BS is superior to that of the neighboring cell. Upon determining the handover of the UE, the serving BS transmits a handover request message to a target BS (step S540).

Upon receiving the handover request message, the target BS controls admission of the UE (step S550). The target BS may determine admission of the UE when there are enough radio resources usable by the target BS and allocatable to the UE. Upon determining admission of the UE, the target BS transmits a handover request ACK message to the serving BS (step S560). The handover request ACK message may include a plurality of parameters required for access, such as a cell-radio network temporary identify (C-RNTI), a random access signature, etc., provided from the target BS. The C-RNTI is used to identify UEs within a cell so that an RRC connection of the UEs within the cell can be identified.

The target BS assigns a random access signature for the handover to the UE via the serving BS. The random access signature includes non-contention based random access signatures S1 and contention based random access signatures S2. A target BS first assigns the non-contention based random access signatures S1 to the UE, and then if the non-contention based random access signatures S1 are insufficient, the target BS assigns one of the contention based random access signatures S2 to the UE.

When the non-contention based random access signatures S1 are assigned to the UE, the target BS assigns to the UE an RACH slot duration for using the non-contention based random access signatures S1. The RACH slot duration may be determined in consideration of a transmission delay time or the like through an X2 interface or an S1 interface. During the RACH slot duration, the target BS does not assign the same non-contention based random access signature S1 to different UEs, and thus collision is avoided between the UEs using the RACH. That is, the UE can exclusively use a specific signature during the RACH slot duration.

In general, the number of random access signatures is limited. For example, the number of random access signatures is limited to 64 in a 3GPP LTE system. The number of the non-contention based random access signatures S1 is small in the total of 64 random access signatures. When a plurality of UEs simultaneously perform handovers, the target BS may assign all of the non-contention based random access signatures S1 and thus the non-contention based random access signatures S1 may no longer be assignable. If the target BS assigns no signature since there is no assignable non-contention based random access signatures S1, the UE has to select and use the random contention based random access signatures S2. In this case, the UE performs a random access in a competitive manner with respect to other UEs for obtaining uplink radio resources. In the contention based random access process, a handover UE may not be able to access the target BS at one time and thus may repeatedly transmit a random access preamble. Accordingly, a handover delay may occur.

In order to prevent the handover delay, when the non-contention based random access signatures S1 are insufficient, the target BS selects one of the contention based random access signatures S2 and assigns the selected contention based random access signature S2 to the UE performing a handover. In addition, the target BS allocates an RACH slot duration for using the contention based random access signature S2 to the UE. That is, the signature selected from the contention based random access signatures S2 is used as the non-contention based random access signature S1. It is assumed herein that the non-contention based random access signatures S1 are insufficient and thus the contention based random access signature S2 is assigned to the UE performing the handover.

Upon receiving the handover request ACK message from the target BS, the serving BS transmits a handover command message to the UE (step S570). The handover command message is used to inform the UE that the handover is performed. The handover command message may include a plurality of parameters required for the handover, such as, the C-RNTI, the random access signature, etc., provided from the target BS. A series of above operations starting from the HO decision of the serving BS to the transmission of the handover command message is referred to as a handover preparation process.

Upon receiving the handover command message, the UE is time synchronized with the target BS (step S580). The UE transmits a random access preamble to the target BS by using the random access signature provided from the target BS.

The target BS transmits a random access response to the UE. That is, after receiving the random access preamble, the target BS allocates UL radio resources to the UE, and transmits UL radio resource allocation information and timing offset information (i.e., time advance (TA)). In this case, the random access response is indicated by a C-RNTI assigned to the UE. The random access response may be transmitted through a DL-SCH. The C-RNTI may be transmitted through a DL L1/L2 control channel or DL L1/L2 control signaling. The contention based random access signature S2 assigned to the UE may be randomly selected by other UEs attempting an initial access and thus may be used during the same RACH slot duration. However, since the random access response is indicated not by the RA-RNTI but by the C-RNTI, only the UE performing the handover can transmit a handover confirm message by using the UL radio resources. Even if the signature used by the UE is the contention based random access signature S2, the same effect as non-contention based random access can be obtained by allowing the radio resources allocated to the UE to be indicated by the C-RNTI.

The UE transmits a handover confirm message to the target BS (step S600). The handover confirm message indicates completion of the handover procedure of the UE. The target BS can verify the C-RNTI from the handover confirm message. Thereafter, the target BS allocates the radio resources to the UE and transmits/receives data to/from the UE.

FIG. 14 is a flowchart showing a method for performing a handover according to another embodiment of the present invention. It is a handover process of a target BS aspect.

Referring to FIG. 14, when a handover request message is received from a BS (e.g., the serving BS in FIG. 13) providing a communication service to a current UE, a BS (e.g. the target BS in FIG. 13) selects a random access (RA) signature to be assigned to a UE performing a handover (step S610). When non-contention based RA signatures are insufficient, the BS selects a contention based RA signature and assigned the contention based RA signature to the UE. Then, the BS reports a C-RNTI for identifying an RRC connection. The BS assigns an RACH slot duration in which the UE transmits an RA preamble by using the contention based RA signature.

The BS receives the RA preamble from the UE (step S620). The UE transmits the RA preamble by using the contention based RA signature assigned by the BS during the RACH slot duration. In this case, another UE attempting an initial access can attempt a random access by using the same RA signature during the RACH slot duration. For example, assume that a first UE performs a handover, a second UE attempts an initial access, and the first UE and the second UE attempt a random access by using the same signature during an RACH slot duration allocated to the first UE. In this case, since the BS transmits an RA response first to the first UE, the second UE cannot receive the RA response and thus has to reattempt the random access. For effective operation of the random access of the first UE and the second UE, the BS can transmit the RA response both to the first UE and the second UE.

The BS transmits to the first UE the RA response addressed by the C-RNTI (step S630), and transmits to the second UE the RA response addressed by the RA-RNTI (step S640). The RA response addressed by the C-RNTI includes information on uplink radio resources allocated to the first UE. The RA response addressed by the RA-RNTI includes information on uplink radio resources allocated to the second UE. The uplink radio resources allocated to the first UE and the uplink radio resources allocated to the second UE belong to different radio resource regions. However, in a case where the BS can detect collision between an RA preamble of the first UE and an RA preamble of the second UE, if preamble collision does not actually occurs, the uplink radio resource region allocated to the first UE may be the same as that allocated to the second UE.

In a case where the first UE and the second UE perform random accesses by using the same RA signature during the same RACH slot duration, an RA response is transmitted twice to satisfy not only the random access of the first UE performing a handover but also the random access of the second UE attempting an initial access. In addition, a second UE′ random access delay caused by the random access of the first UE can be reduced.

If the RA response addressed by the C-RNTI and the RA response addressed by the RA-RNTI specify different radio resource regions, it is possible to reduce interference occurring when uplink radio resources are shared between a UE, to which timing offset information (i.e., time advance (TA)) is applicable, and another UE. If the timing offset information is applicable to both the first UE and the second UE, radio resource transmission messages of the two UEs can be successfully transmitted. Delays of the random accesses of the first UE and the second UE can be reduced.

<Method for Performing Handover Based on DRX Level>

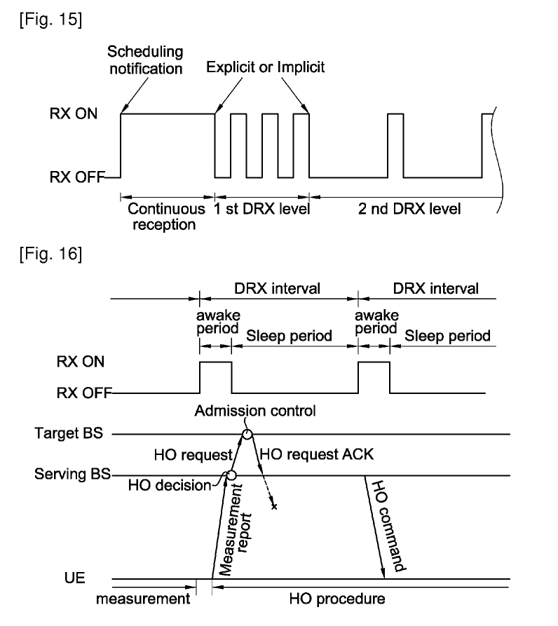

FIG. 15 shows a reception mode level of a UE.

Referring to FIG. 15, a reception mode of the UE may operate either in a continuous reception level for continuously receiving data or in a discontinuous reception (DRX) level for discontinuously receiving data. The DRX level includes a 1^{st} DRX level and a 2^{nd} DRX level.

A reception power off (RX OFF) denotes a state in which the UE cannot receive data. The RX OFF state or a time period in which the RX OFF state is maintained is referred to as a sleep period. A reception power on (RX ON) denotes a state in which the UE can receive data. The RX ON state or a time period in which the RX ON state is maintained is referred to as an awake period. The sleep period of the 2^{nd} DRX level is longer than the sleep period of the 1^{st} DRX level. The 1^{st} DRX level having a relatively short sleep period is also referred to as a short-DRX. The 2^{nd} DRX level having a relatively long sleep period is also referred to as a long-DRX. The continuous reception level is also referred to as a non-DRX.

When scheduling notification is received from a BS, that is, when radio resources are allocated, the UE is switched to the continuous reception level and then receives data. If data transmission from the BS is sporadic or if there is no data transmission during a predetermined inactive time, the UE switches to the 1^{st} DRX level. In this case, the BS can transmit a control message so that the UE can switch to the 1^{st} DRX level, which is referred to as an explicit reception level change. Alternatively, after the inactive time elapses, the UE can switch to the 1^{st} DRX level without the aid of the BS, which is referred to as an implicit reception level change. Switching from the 1^{st} DRX level to the 2^{nd} DRX level may also be achieved in the explicit reception level change manner or the implicit reception level change manner. An inactive time used for switching from the continuous reception level (i.e., non-DRX) to the 1^{st} DRX level (i.e., short-DRX) is referred to as a 1^{st} inactive time. An inactive time used for switching from the 1^{st} DRX level (i.e., short-DRX) to the 2^{nd} DRX level (i.e., long-DRX) is referred to as a 2^{nd} inactive time. The 1^{st} inactive time and the 2^{nd} inactive time may be predetermined or may be informed by the BS.

The UE may switch to the 1^{st} DRX level or the 2^{nd} DRX level under the control of the BS. The BS can control the DRX level of the UE by constantly monitoring a buffer status for data to be transmitted to the UE. The BS and the UE can operate in the same period through synchronization. A 1^{st} DRX interval and a 2^{nd} DRX interval of the UE may be determined by the BS according to a type and amount of data transmitted to the UE.

When in the sleep period, the UE is powered on for reception periodically or when necessary. Then, the UE enters the awake period, and determines whether there is data transmitted to the UE itself. While monitoring a channel during the awake period, the UE returns to the sleep period when there is no data transmitted to the UE. According to a length of the sleep period, the UE can operate in the 1^{st} DRX level and the 2^{nd} DRX level in a flexible manner.

Hereinafter, a handover performed at each reception mode level of a UE will be described.

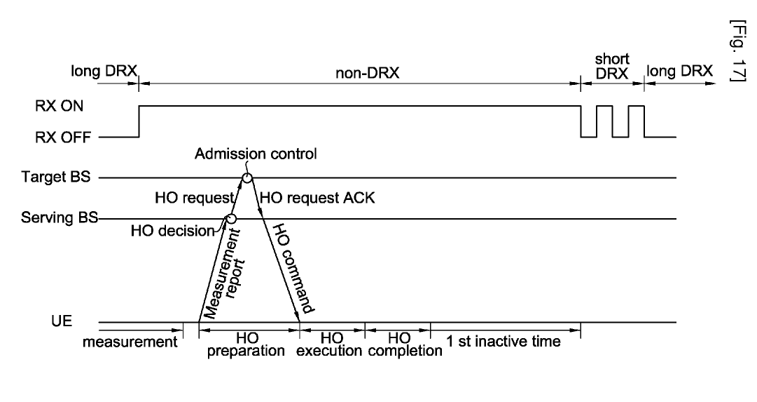

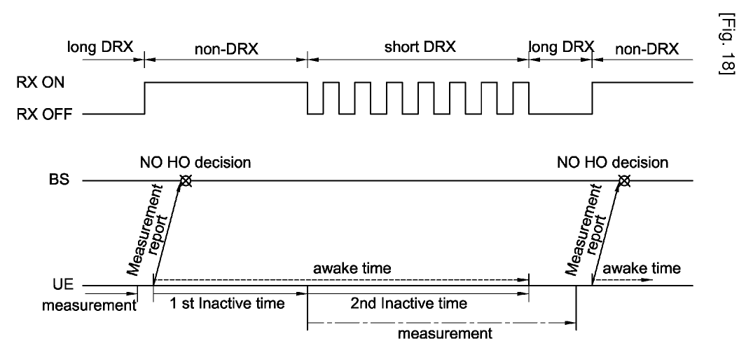

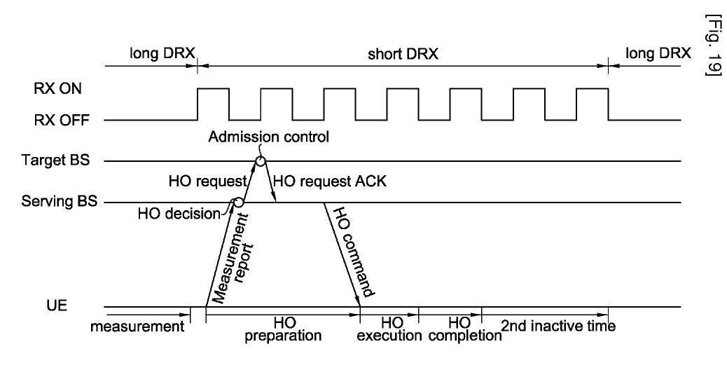

FIG. 16 shows a handover procedure in a long-DRX.

Referring to FIG. 16, when a channel condition of a serving BS decreases to below a predetermined threshold, the UE measures a channel condition of a neighboring cell. The channel condition of the neighboring cell can be measured during a sleep period and cannot be measured during an awake period. Therefore, when in a non-DRX state, the serving BS assigns a measurement gap to the UE, and then the UE measures the channel condition of the neighboring cell. When in a DRX state, the UE can measure the channel condition of the neighboring cell during the sleep period. Since the UE has a sufficient sleep period in the long-DRX, the channel condition of the neighboring cell can be sufficiently measured without the measurement gap.

Upon measuring the channel condition of the neighboring cell, the UE transmits a measurement report message to the serving BS periodically or in an event-driven manner.

Upon receiving the measurement report, the serving BS compares its channel condition with the channel condition of the neighboring cell according to the received measurement report message, and then makes a HO decision for the UE. If the serving BS determines that HO is not necessary, no response is transmitted to the UE. Upon receiving no response from the serving BS, the UE continues to measure the channel condition of the neighboring cell after a specific time elapses.

As a result of the HO decision, if the serving BS determines that HO is necessary, the serving BS transmits a HO request message to a target BS.

Upon receiving the HO request message, the target BS provides admission control to the UE to determine whether the UE will be admitted.

If the target BS determines admission of the UE, the target BS transmits a HO request ACK message to the serving BS.

Upon receiving the HO request ACK message, the serving BS transmits a HO command message indicating the start of a handover procedure to the UE together with information required for a handover to the target BS.

A series of operations starting from the HO decision to the transmission of the HO command message is referred to as a handover preparation process. During the handover preparation process, the UE cannot know the HO decision determined by the serving BS and the target BS. The UE can receive the HO command message only when in the awake period. The UE enters a long sleep period before the HO command message is received. Therefore, the BS has to wait for a next awake period of the UE in order to transmit the HO command message to the UE. Even in the long-DRX in which data transmission is infrequent, the handover procedure, which needs to be performed in a short time period, experiences a delay due to the long sleep period. That is, the long-DRX results in a handover delay, and thus adversely affects performance of the communication system.

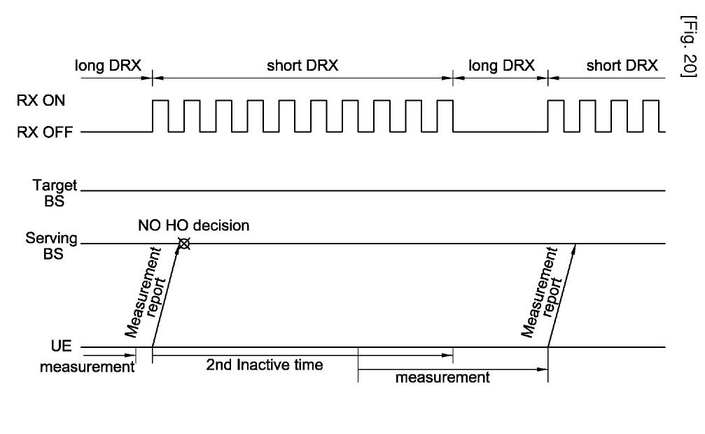

FIG. 17 shows a method for performing a handover in a continuous reception level (i.e., a non-DRX).

Referring to FIG. 17, after reporting measurement on a channel condition of a neighboring cell, a UE can switch to the continuous reception level and wait for a HO command message. Since the UE remains in an RX ON state, the UE can immediately receive the HO command message from a serving BS. However, if a handover does not occur, a handover delay may occur when a reception mode level of the UE frequently changes. In addition, unnecessary battery consumption may occur.

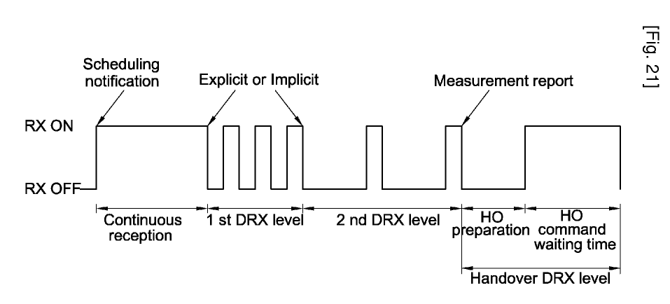

FIG. 18 shows a case where no handover occurs in a continuous reception level (i.e., a non-DRX).

Referring to FIG. 18, a UE may switch to the continuous reception level after reporting measurement on a channel condition of a neighboring cell, and may wait for a HO command message. This is a case where a handover does not occur. If a serving BS determines not to perform a handover in a handover preparation process or if a target BS does not admit the UE, the serving BS does not transmit the handover command message to the UE.

In practice, the measurement of the channel condition of the neighboring cell and the transmission of the measurement report may be carried out multiple times periodically or in an event-driven manner. When the serving BS receives the measurement report generated as described above, the serving BS does not determine a handover in every time. Therefore, if the DRX level of the UE switches to the continuous reception level in every time after transmitting the measurement report, the UE remains in an awake period for an unnecessarily long time period.

While transmitting the measurement report, the UE switches to the continuous reception level (i.e., non-DRX) and thus waits for the handover command. Once the UE switches to the continuous reception level, the UE waits for the handover command during a predetermined time period. In the continuous reception level, the UE cannot measure the channel condition of the neighboring cell, and unnecessarily consumes a battery for a long time period. When a 1^{st} inactivity time expires, the UE switches to a short-DRX. In the short-DRX, the UE can measure the channel condition of the neighboring cell by using a sleep period. When a 2^{nd} inactivity time elapses, the UE switches to a long-DRX. If the UE cannot measure the channel condition of the neighboring cell during the short-DRX, the UE can measure the channel condition of the neighboring cell with a sufficient measurement time in the long-DRX. Thereafter, the UE re-performs the measurement reporting on the channel condition of the neighboring cell. Repetition of such an operation results in not only unnecessary battery consumption of the UE but also decrease in a time for measuring the channel condition of the neighboring cell. Therefore, a handover delay occurs.

FIG. 19 shows a method for performing a handover in a short-DRX.

Referring to FIG. 19, after reporting measurement on a channel condition of a neighboring cell, a UE can switch to the short-DRX and wait for a HO command message. Since the UE has a short sleep period, the UE can receive the HO command message faster than a handover in a long-DRX. However, if the handover does not occur or if retransmission is requested since an error occurs one or more times in the handover command message, the handover may be delayed and unnecessary battery consumption may occur.

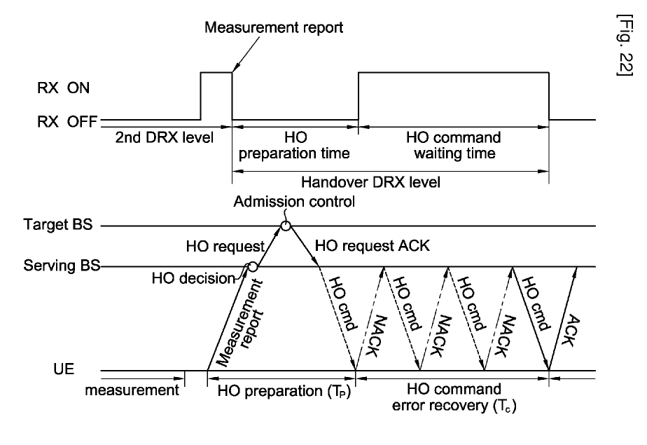

FIG. 20 shows a case where a handover does not occur in a short-DRX.

Referring to FIG. 20, a UE switches to the short-DRX after reporting measurement on a channel condition of a neighboring cell, and waits for a HO command message. This is a case where a handover does not occur. If a serving BS determines not to perform the handover, the UE waits for the HO command message that can be transmitted from the serving BS during a 2^{nd} inactivity time. Thus, a next measurement on the channel condition of the neighboring cell may be delayed. In addition, if the UE has received the HO command message from the serving BS but retransmission is requested since an error is detected one or more times, the serving BS can transmit the message only when the UE operates in an awake period using the short-DRX, which may lead to a handover delay.

In general, a 1^{st} inactive time used in the DRX level is approximately 1 sec, and a 2^{nd} inactive time is approximately 4 sec. The UE may switch to the short-DRX or the long-DRX after reporting the measurement on the channel condition of the neighboring cell. In this case, a problem arises in which the UE remains in the awake period for an unnecessarily long period of time. If the UE remains in the awake period for a long period of time, a time for re-measuring the channel condition of the neighboring cell is also delayed to that extent. Thus, the BS which determines a HO time based on the measurement report has to determine the HO time by delaying the handover of the UE. The handover delay results in quality degradation of a wireless communication service, such as, an unsuccessful radio link, deterioration in reception performance of the UE, etc.

Hereinafter, a method for reducing battery consumption, for rapidly measuring a channel condition of a neighboring cell, and for reducing a handover delay will be described in a case where a handover is performed by a UE in a long-DRX in which data is infrequently transmitted and received.

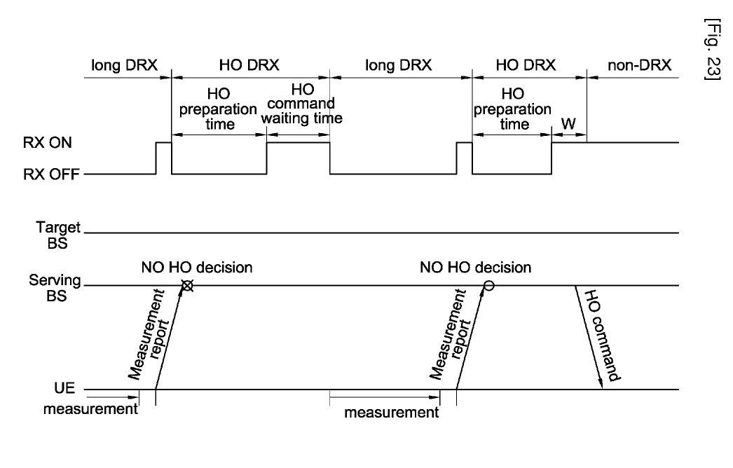

FIG. 21 shows a reception mode level of a UE according to an embodiment of the present invention.

Referring to FIG. 21, a reception mode of the UE may operate in a continuous reception level, a 1^{st} DRX level, a 2^{nd} DRX level, and a handover DRX level (i.e., a 3^{rd} DRX level). The handover DRX level is a discontinuous reception level defined so that the UE in the 2^{nd} DRX level can effectively perform a handover. The handover DRX level includes a HO preparation time and a HO command waiting time. The HO preparation time is a time required from when a serving BS determines a handover to when the serving BS transmits a HO command message. The HO preparation time is consumed in a HO preparation process. The HO command waiting time is a specific time assigned to receive a handover command. In the HO preparation time, the UE has an RX OFF state, that is, a sleep period. In the HO command waiting time, the UE has an RX ON state, that is, an awake period.

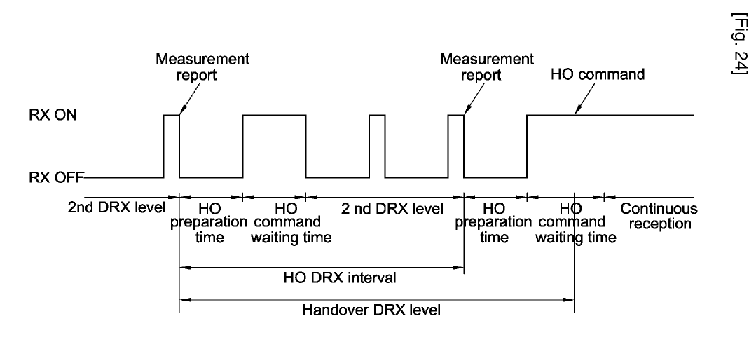

FIG. 22 shows a method for performing a handover by using a handover DRX level according to an embodiment of the present invention.

Referring to FIG. 22, in the handover DRX level, a HO preparation time Tp and a HO command waiting time Tc can be set to a particular value for a target BS. For all cells belonging to a neighbor cell list, a serving BS can share, in advance, values corresponding to the HO preparation time and the HO command waiting time with the UE. A measurement report may be used to inform which value will be used among values included in the neighbor cell list. That is, the HO preparation time and the HO command waiting time are used to synchronize the UE and the BS according to a specific cell of which a channel condition will be measured.

The HO preparation time Tp can be defined as follows.

Handover Preparation Time(Tp)=measurement report propagation delay+HO decision processing delay+HO request message processing delay+HO request propagation delay+admission control processing delay+HO request ACK processing delay+HO request ACK propagation delay+HO command processing delay+HO command propagation delay

The HO preparation time Tp is obtained by summing time periods required for measurement report transmission, for HO decision, for HO request message processing, for HO request transmission, for UE admission control processing, for HO request ACK processing, for HO request ACK transmission, for HO command processing, and for HO command transmission. The HO preparation time is defined as a time required for making a HO decision between the serving BS and the target BS before the HO command is generated. Since, the UE has no message to be received during the HO preparation time, the UE can enter the sleep period.

The HO command waiting time Tc can be defined as follows.

Handover Command Waiting Time(Tc)=No. of HARQ process channels (n TTI)×maximum No. of retransmission=HARQ RTT×maximum No. of retransmission

The HO command waiting time Tc is obtained by multiplying the number of hybrid automatic request (HARQ) process channels by a maximum retransmission number, and can be defined as a time corresponding to a maximum retransmission time assigned for HARQ. The HO command waiting time can also be defined as a time required for a HO command error recovery using HARQ. The UE cannot know whether the HO command is transmitted. Thus, the UE has to prepare to receive the HO command after the HO preparation time elapses. The HO command message requires high reliability. If the HO command message is configured in a significantly robust manner when transmitted, most of errors can be recovered by HARQ. Downlink data is transmitted using ‘n channel stop and wait’. Thus, the HO command waiting time can be defined as n×maximum No. of HARQ retransmission. When the HO command message is not received during the HO command waiting time, the UE determines that the handover does not occur, and thus returns to a 2^{nd} DRX level (i.e., long-DRX).

In general, a 1^{st} inactive time currently set is approximately 1 sec (i.e., 1000 ms). However, when downlink data is transmitted using ‘n channel stop and wait’, the HO command waiting time is n×maximum No. of HARQ retransmission (ms). If it is assumed that a HO command message is transmitted using ‘7 channel stop and wait’ and a maximum HARQ retransmission number of 4 when using HARQ, the HO command waiting time is 28 ms. This value may vary according to a cell property. Even if it takes a maximum of 50 ms according to a cell, battery saving can be achieved about 20 times higher than a case of using the conventional continuous reception level.

Although it has been described above that the 1^{st} DRX level is switched to the 2^{nd} DRX level and thereafter the 2^{nd} DRX level is switched to the handover DRX level, this is for exemplary purposes only. Thus, when a handover is performed in the 1^{st} DRX level, the 1^{st} DRX level may be immediately switched to the handover DRX level. In addition, even if the handover is performed in the continuous reception level, the handover DRX level can be used to reduce battery consumption of the UE.

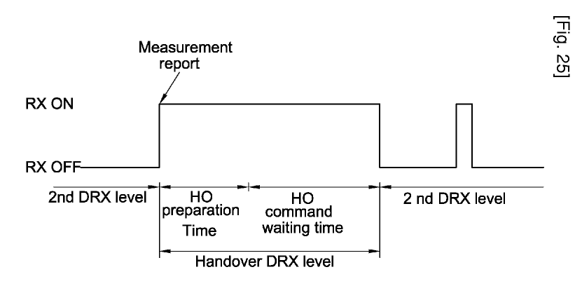

FIG. 23 shows another example of a method for performing a handover by using a handover DRX level.

Referring to FIG. 23, a UE measures a channel condition of a neighboring cell during a sleep period of a long DRX, and transmits a measurement report to a BS. It is not mandatory for the BS to make a HO decision whenever the measurement report is received. Thus, the measurement report may be transmitted several times before an event for performing a handover is actually generated.

The UE operates in a handover DRX level whenever the UE transmits the measurement report. That is, the UE operates in a handover DRX level in both cases of occurrence and non-occurrence of a handover after transmitting the measurement report.

If the handover does not occur after transmitting the measurement report, the UE remains in a sleep period during a HO preparation time and remains in an awake period during a HO command waiting time. If the UE does not receive a HO command message from the BS during a pre-defined interval of the handover DRX level, the UE determines that the handover does not occur. Then, returning to the previous long DRX level, the UE has a long sleep period and measures the channel condition of the neighboring cell.

Otherwise, if the handover occurs after transmitting the measurement report, the UE receives the HO command during the HO command waiting time and performs the handover. Immediately after receiving the HO command message, the UE switches from the handover DRX level to the continuous reception level (i.e., non-DRX) in order to perform the remaining handover procedure. In this case, it is no longer necessary for the UE to measure the channel condition of the neighboring cell.

FIG. 24 shows a method for performing a handover according to another embodiment of the present invention.

Referring to FIG. 24, a handover DRX level includes at least one HO DRX interval. The HO DRX interval includes a HO preparation time, a HO command waiting time, and a long DRX level. That is, the HO DRX interval is defined as a time interval from when a UE transmits a first measurement report by measuring a channel condition of a neighboring cell to when the UE transmits a second measurement report. The handover DRX level is defined as a time interval from when the UE transmits the first measurement report to when the UE receives a HO command from a BS.

When the HO command is received while the HO DRX interval is repeated, the UE switches to a continuous reception level and then performs the remaining handover procedure.

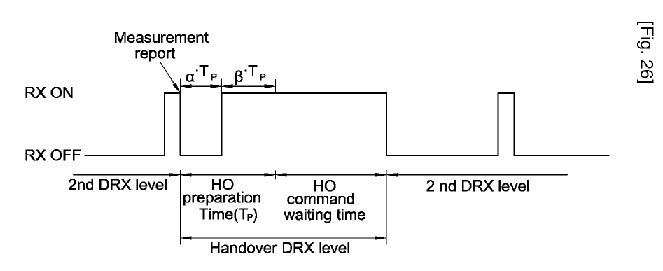

FIG. 25 shows a method for performing a handover according to another embodiment of the present invention.

Referring to FIG. 25, a handover DRX level includes a HO preparation time and a HO command waiting time. Both the HO preparation time and the HO command waiting time remain in an awake period.

The HO preparation time may be approximately tens of milli-seconds, i.e., 10 to 20 ms. Although it is a short period of time, a HO command can be promptly processed before a UE awakes from a sleep period determined by a BS, and can be ready to be transmitted from the BS. When the UE is in the sleep period during the HO preparation time, the HO command may be received with a slight delay. Battery consumption can be reduced by maintaining the sleep period during the HO preparation time. However, if this has a significant effect more on a handover delay than a gain, there is no need to remain in the sleep period during the HO preparation time. Therefore, in the handover DRX level, the HO preparation time can be maintained in the awake period. Whether the HO preparation time is maintained in the awake period or the sleep period may be reported by the BS to the UE. For example, an inter-cell handover to a serving BS and a target BS may take a long processing time, but an inter-sector handover from one BS may be performed in a short period of time.

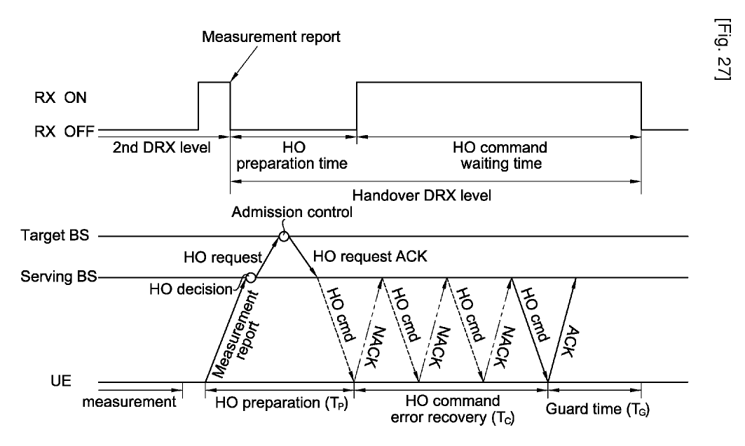

FIG. 26 shows a method for performing a handover according to another embodiment of the present invention.

Referring to FIG. 26, a handover DRX level includes a HO preparation time and a HO command waiting time. The HO preparation time may have a sleep period and an awake period in a predetermined ratio.

When it is unnecessary for the entire HO preparation time to be maintained in the sleep period or the awake period, only a portion of the HO preparation time can have the awake period (or the sleep period). A state of the HO preparation time Tp can be regulated as shown:

Math Figure 1 Tₚ=α·Tp+β·Tp [Math. 1]

where α denotes a proportion of applying the sleep period, and β denotes a proportion of applying the awake period. α+β=1, 0≦α≦1, and 0≦β≦1. By regulating α and β the sleep period and the awake period can be regulated in the HO preparation time. Herein, α and β may be predetermined or may be regulated by a UE. In addition, a BS may determine α or β and report the determined value to the UE.

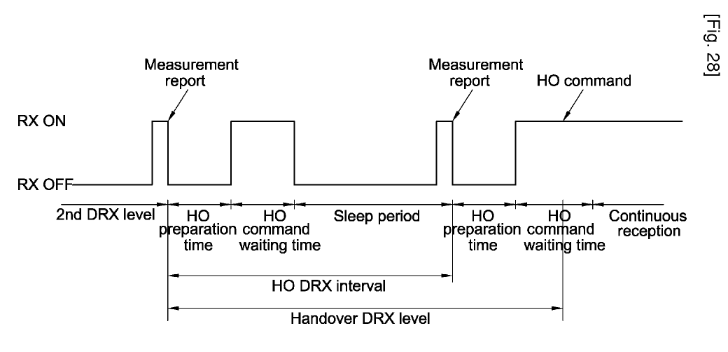

FIG. 27 shows a method for performing a handover according to another embodiment of the present invention.

Referring to FIG. 27, a handover DRX level includes a HO preparation time and a HO command waiting time. The HO command waiting time includes a HO command error recovery time T_{C} and a guard time T_{G}. That is, the HO command waiting time can be regulated by allowing the guard time to be included in the HO preparation time.

The HO command waiting time is important in that a HO command message has to be correctly received without a delay. When the HO command waiting time is setup, there is a need to consider not only a wireless communication environment but also a transmission delay of data over a backbone network. For this, the guard time may be further included in the HO command waiting time. The guard time may be predetermined according to a system. Alternatively, a BS may determine the guard time and report the determined guard time to a UE.

FIG. 28 shows a method for performing a handover according to another embodiment of the present invention.

Referring to FIG. 28, a handover DRX level includes at least one HO DRX interval. The HO DRX interval includes a HO preparation time, a HO command waiting time, and a sleep period. The sleep period may be determined to a constant time or a variable time. That is, the HO DRX interval is defined as a time interval from when a UE transmits a first measurement report by measuring a channel condition of a neighboring cell to when the UE transmits a second measurement report. The handover DRX level is defined as a time interval from when the UE transmits the first measurement report to when the UE receives a HO command from a BS.

When the HO command is received while the HO DRX interval is repeated, the UE switches to a continuous reception level and then performs the remaining handover procedure.

It has been described above that a HO preparation time and a HO command waiting time in a handover DRX level can be determined to a particular value according to a procedure performed between a serving BS and a target BS and between the serving BS and a UE. That is, a DRX level can be determined to a particular value for one neighboring cell. However, in a case where the UE transmits a measurement report of channel conditions of a plurality of neighboring cells, it may be unclear which cell will be used among the plurality of neighboring cells when the UE determines a HO DRX interval or the handover DRX level. In this case, the HO preparation time may be used as an awake period. In addition, the HO DRX interval or the handover DRX level may be determined based on a cell requiring a longest time and included in a neighbor cell list.

Every function as described above can be performed by a processor such as a microprocessor based on software coded to perform such function, a program code, etc., a controller, a micro-controller, an ASIC (Application Specific Integrated Circuit), or the like. Planning, developing and implementing such codes may be obvious for the skilled person in the art based on the description of the present invention.

Although the embodiments of the present invention have been disclosed for illustrative purposes, those skilled in the art will appreciate that various modifications, additions and substitutions are possible, without departing from the scope of the invention. Accordingly, the embodiments of the present invention are not limited to the above-described embodiments but are defined by the claims which follow, along with their full scope of equivalents.

1. A method for performing a handover by a user equipment from a serving base station to a target base station, the method comprising:
transmitting a random access preamble to the target base station;
receiving a random access response in response to the random access preamble;
after receiving the random access response, transmitting a handover confirm message for indicating completion of the handover between the user equipment and the target base station; and
transmitting a packet data sequence number report message indicating packet data received from the serving base station in a process of performing the handover.

2. The method of claim 1, wherein the handover confirm message and the packet data sequence number report message are multiplexed.

3. The method of claim 1, wherein the packet data sequence number report message indicates a sequence number of packet data which is last received from the serving base station.

4. The method of claim 1, wherein the packet data sequence number report message indicates a sequence number of erroneous packet data which is received from the serving base station.

5. A method for performing a handover by a target base station in a wireless communication system, the method comprising:
receiving from a user equipment a random access preamble comprising contention-based random access signatures, the contention-based random access signatures are selected by the target base station; and
transmitting a random access response addressed by an identifier for the user equipment within a cell in response to the random access preamble.

6. The method of claim 5, wherein the identifier is Cell-Radio Network Temporary Identity (C-RNTI).

7. The method of claim 5, further comprising receiving a handover confirm message from the user equipment through uplink radio resource, the uplink radio resources information is comprised in the random access response.

8. A method for performing a handover by a user equipment, the method comprising:
measuring a channel condition of a neighboring cell;
reporting the channel condition to a base station; and
receiving a handover command in response to the reporting, wherein the base station makes a handover decision, the user equipment operates in a sleep period for not receiving data during a handover preparation time required to transmit the handover command, and operates in an awake period during a handover command waiting time for receiving the handover command after the handover preparation time is over.

9. The method of claim 8, wherein the handover command waiting time is for which the base station decides and requests the user equipment's handover to a target base station and is approved the user equipment's handover from the target base station.

10. The method of claim 8, wherein the handover command waiting time is for performing a maximum retransmission of hybrid automatic repeat request (HARD).

11. The method of claim 10, wherein the handover command waiting time further comprises additional guard time.

12. The method of claim 8, wherein the reporting of the channel condition is transmitted after switching from a first discontinuous reception (DRX) level to a second DRX level, the second DRX level having longer non-reception time than a first DRX level.
